(19) United States
(12) Patent Application Publication
(10) Pub. No.: US 2007/0106713 A1
(43) Pub. Date: May 10, 2007

(54) Hazard protected file backup system

(75) Inventors: Nicholas J. Allen, Mount Prospect, IL (US); Edmond G. Chenet JR., Elgin, IL (US)

Correspondence Address: QUARLES & BRADY LLP, 411 E. WISCONSIN AVENUE, SUITE 2040, MILWAUKEE, WI, 53202-4497, US

(73) Assignee: Network Blackbox, Inc.

(21) Appl. No.: 11/593,953

(22) Filed: Nov. 7, 2006

Related U.S. Application Data
(60) Provisional application No. 60/734,661, filed on Nov. 8, 2005.

(51) Int. Cl. G06F 17/30

(52) U.S. Cl. 707/204

(57) ABSTRACT

A hazard protected file backup system includes a storage unit and a backup server. The storage unit is operable to receive and store digital data. A hazard resistant enclosure surrounds the storage unit. The backup server is operable to receive designated backup files and store at least some of the designated backup files on the storage unit.

### CROSS-REFERENCE TO RELATED APPLICATIONS

This is a non-provisional application based upon U.S. provisional patent application Ser. No. 60/734,661, entitled “HAZARD PROTECTED FILE BACKUP SYSTEM”, filed Nov. 8, 2005.

### STATEMENT REGARDING FEDERALLY SPONSORED RESEARCH OR DEVELOPMENT

Not applicable

### BACKGROUND OF THE INVENTION

The present invention relates generally to networked computer systems and, more particularly, to a hazard protected file backup system.

The use of computer systems has expanded greatly in recent years. The proliferation of electronic tools, such as the internet, e-mail, and automation systems has greatly increased the reliance by businesses on these resources. For a small to medium size business the administration and maintenance of a computer network is a time-consuming task and often requires the formation of an internal information technology staff or the hiring of an outside consultant.

Businesses typically select different topologies depending on their size and unique characteristics. Some networks may have a centralized file management system, such as a file server, with associated network drives. Smaller networks may simply consist of linked computers, commonly referred to as a peer-to-peer network. The use of file backup systems to protect important business data are sometimes used ineffectively. For example, an automatic file backup may be performed on files stored on a network server. However, setting up these automatic backups requires IT expertise, and many businesses have poor backup configurations or do not back up consistently. Hence, as many as 30-40% of backups maybe unusable. Another limitation of scheduled automatic backups is the time delay between backups. Important files may be created or modified in the interim period, and these files may be inadvertently lost, replaced, or corrupted before they can be backed up.

File backup systems, may be consistently used on network drives, but rarely are individual business workstations (e.g., desktop or notebook computers) backed up. Users of these computers create important business data every day, but the files are not backed up unless they are manually stored on the network drive. The problem associated with backing up individual workstations is exacerbated in networks that do not have a file server. Often, workstations on these networks do not automatically back up any files. As the use of notebook computers in enterprise environments continues to increase, the backup problem only increases. Because notebook computers are used in situations where connections to the network or file server may be infrequent, it is difficult for a user to copy files to the file server regularly.

Another problem associated with file backup systems is the susceptibility of the backup medium to hazards, such as fire, flooding, impact, etc. Most businesses do not use redundant backup systems where backups are stored in multiple locations remote from one another. Hence, if the backup system experiences hazardous conditions, the backups may be lost. Some businesses try to address this problem by storing the backup media, such as CDROMs or magnetic tape, in hazard resistant containers, such as media safes. However, the usefulness of this approach is limited by the frequency at which the backup media is created and stored in the media safe.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

### BRIEF SUMMARY OF THE INVENTION

One aspect of the present invention provides a hazard protected file backup system which includes a first storage unit operable to receive and store digital data, a hazard resistant enclosure surrounding the storage unit, and a backup server operable to receive designated backup files and store at least some of the designated backup files on the first storage unit.

The system according to the present invention can include a second storage unit operable to receive and store digital data, the backup server operable to store the designated backup files on the second storage unit, wherein the first storage unit stores a subset of the designated backup files. The first storage unit and/or the second storage unit can be expandable to include additional storage capacity. For example, the first storage unit and/or the second storage unit can be a redundant array of hard disk drives where, in the event of a failed member disk drive, the failed member data can be restored on a remaining disk drive.

In other aspects, the hazard protected file backup system can include an access-controlled enclosure surrounding the hazard resistant enclosure and the backup server. Further, a computer can be connected to the backup server, where the computer is operable to execute backup client software to continuously monitor the computer to identify at least some of the designated backup files for continuous backup. The backup client software can have a status monitoring functionality that indicates the status of the backup server, where the status monitoring functionality has at least a current availability of the backup server.

In alternative embodiments, the storage unit is operable to store a virtual folder for the computer, the virtual folder including a backup folder for continuous backup and an archive folder for permanent backup. The backup client software is further operable to transfer the designated target files to the backup server for storage in the backup folder.

In other aspects, the storage unit is operable to store a backup folder for the computer, wherein the backup client software is further operable to transfer the designated target files to the backup server for storage in the backup folder responsive to the backup server being available and to store the designated target files in a backup queue responsive to the backup server being unavailable.

The present invention can include a heat transfer device connected to the hazard resistant enclosure for transferring heat from the storage unit to an outside of the hazard resistant enclosure. The heat transfer device automatically disconnects from the outside in the event of a fire. The heat transfer device can be a heat pipe, for example, or other heat transfer devices.

Yet other aspects of the present invention provide a computer system including a computer and a backup server. The computer is operable to execute backup client software to continuously monitor the computer to identify designated target files for continuous backup. The backup server includes a storage unit and is operable to store a virtual folder for the computer. The virtual folder includes a backup folder for continuous backup and an archive folder for permanent backup. The backup client software is further operable to transfer the designated target files to the backup server for storage in the backup folder. A hazard resistant enclosure can surround the storage unit. Alternatively, the storage unit can have a first storage unit, a second storage unit. A hazard resistant enclosure surrounds the first storage unit where the archive folder includes a hazard protected folder which is a subset of the backup folder, and the first storage unit stores the hazard protected folder.

Yet another aspect of the present invention is seen in a computer system including a computer and a backup server. The computer is operable to execute backup client software to continuously monitor the computer to identify designated target files for continuous backup. The backup server includes a storage unit operable to store a backup folder for the computer. The backup client software is further operable to transfer the designated target files to the backup server for storage in the backup folder responsive to the backup server being available and to store the designated target files in a backup queue responsive to the backup server being unavailable. This system according to the present invention can also include a hazard resistant enclosure surrounding the storage unit. Alternatively, the storage unit can have a first storage unit, a second storage unit. A hazard resistant enclosure surrounds the first storage unit where the backup folder includes a hazard protected folder which is a subset of the backup folder, and the first storage unit stores the hazard protected folder.

These and other objects, advantages and aspects of the invention will become apparent from the following description. The particular objects and advantages described herein may apply to only some embodiments falling within the claims and thus do not define the scope of the invention. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of a computer system in accordance with one embodiment of the present invention;

FIGS. 2 and 3 are simplified flow diagrams of methods implemented by backup client software operating on the workstations in the system of FIG. 1 for backing up target files; and

FIG. 4 is an exemplary user display illustrating a virtual backup folder created for a workstation in the system of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

One or more specific embodiments of the present invention will be described below. It is specifically intended that the present invention not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

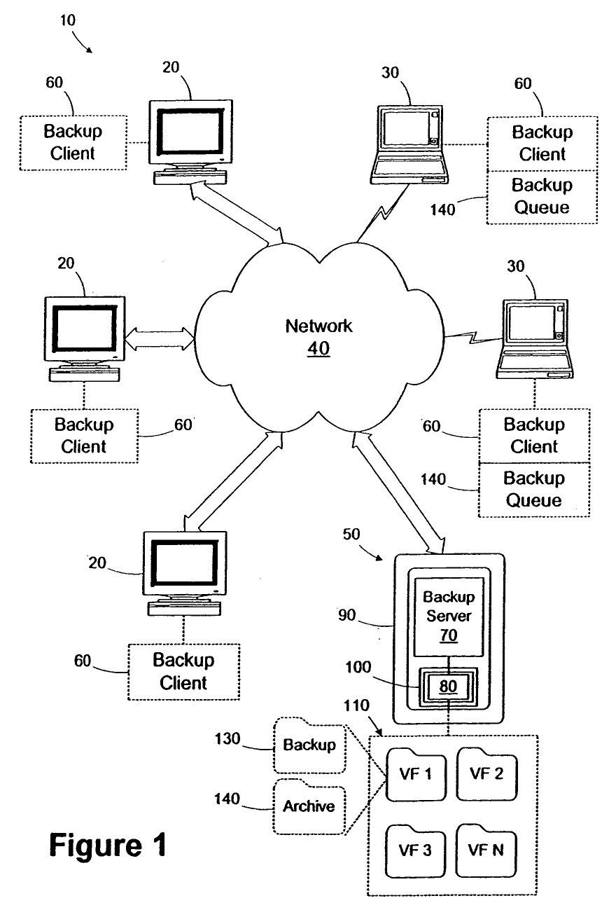

Referring now to the drawings wherein like reference numbers correspond to similar components throughout the several views and, specifically, referring to FIG. 1, the present invention shall be described in the context of a computer system 10. The computer system 10 includes a plurality of workstations 20 and notebook computers 30 communicating over a network 40. The topology of the network 40 may vary depending on the factors such as the number of workstations, layout of the facility, etc. The computer system 10 also includes a hazard protected backup server 50 for backing up important business data. The hazard protected backup server 50 operates as network black box for the computer system. Similar to the black box of an aircraft that continuously monitors and stores critical data associated with the operation of the aircraft, the hazard protected backup server 50 continuously monitors and stores important business data. Moreover, the hazard protected backup server 50 protects the backup data from hazards, such as fire, flooding, and impact. The protective features of the hazard protected backup server 50 are described in greater detail below.

The connections between the various entities in the 10 computer system may vary. For example the connections may include hardwired connections, such as Ethernet, or wireless connections, such as 802.11 connections.

Generally, the hazard protected backup server 50 operates as a networked attached storage (NAS) device in the computer system 10. To configure the backup functionality, a user executes backup client software 60 on the associated workstation 20 or notebook 30. The backup client software 60 allows the user a one-click installation of the backup functionality. Although the user may customize aspects of the backup system, the backup client software 60 employs default rules to configure the interface between the hazard protected backup server 50 and the workstation 20 or notebook 30 to provide a functioning installation for even the most novice of users.

The hazard protected backup server 50 includes a backup server 70 and a storage unit 80 (e.g., hard disk drive). The configuration and capacity of the storage unit 80 may vary depending on the particular needs of the business. In some embodiments, the storage unit 80 may include multiple drives configured in a RAID (redundant array of inexpensive disks) topology. A RAID arrangement allows the data of a failed member of the array to be restored if it should fail and need to be replaced. RAID configurations can include a simple mirror configuration, a multiple drive data striping arrangement, and other arrangements.

As seen in FIG. 1, the backup server 70 is supported in a first enclosure 90, and the storage unit 80 is contained within a second enclosure 100 within the first enclosure 90. In the illustrated embodiment, the first enclosure 90 is an access control enclosure, and the second enclosure 100 is a hazard protected enclosure. Generally, the first enclosure 90 includes an access control device, such as a keypad, biometric device, combination lock, or key lock, the prevents unauthorized access to the hazard protected backup server 50. The second enclosure 100 acts as an active media safe to protect the storage unit 80 from hazards, such as fire, water, and impact. The second enclosure 100 need not be provided with an access control device, and may be accessible once the first enclosure 90 is opened to allow for user upgrades or maintenance.

The protective specifications of the second enclosure 100 may vary depending on the particular implementation. Exemplary, but not limiting, protective standards include a maximum temperature of 125° F. temperature and humidity of 85% within the second enclosure 100 during a fire lasting at least one hour. The second enclosure 100 is also capable of maintaining its protective integrity following a prolonged heating period and an impact from a fall of 30 feet. The second enclosure 100 may also be waterproof to protect the storage unit 80 in the event of a flood. Alternatively, a waterproof barrier that encapsulates the drives that make up the storage unit 80 may be provided, and the encapsulated drives may be placed in the second enclosure 100. Hence, the second enclosure 100 and encapsulating material may cooperate to provide fire and water protection.

Still referring to FIG. 1, in accordance with the default configuration rules, the backup client software 60 creates a virtual folder 110 for the associated device workstation 20 or notebook 30. Hence for N devices that execute the backup client software 60, N virtual folders 110 are created on the hazard protected backup server 50 and stored in the storage unit 80. Each virtual folder 110 is protected by a user-selected password to prevent unauthorized access. A user must provide the password to view or retrieve files in the virtual folder 110.

In the illustrated embodiment, each virtual folder 110 includes a backup folder 120 and an archive folder 130. Generally, the backup folder 120 is used for continuous real-time backup of designated files, file types, or folders. After the space allocated to the backup folder 120 is exhausted, the oldest and, presumably, the least used, files are overwritten by the newer files. In contrast, files stored in the archive folder 130 are stored permanently. If the space allocated to the archive folder 130 is exhausted, a user is informed by the backup client software 60 that files must be deleted from or moved out of the archive folder 130 prior to archiving additional files. For example, the user may transfer files to a CDROM or other permanent storage medium to free up space in their archive folder 130. The backup client software 60 continuously backs up files in the backup folder 120, but the user must manually designate files for permanent storage in the archive folder 130. While no password is required to store files in the backup folder 120, a password is required to retrieve files from the backup folder 120. Also, the user must provide a password prior to storing or retrieving files from the archive folder 130.

Although the following description references transferring files to the hazard protected backup server 50, it is contemplated that complete files need not be transferred. For example byte-level differencing may be used to identify portions of a file that have changed, and only the changed bytes may be transferred, thereby reducing bandwidth.

The backup client software 60 is configured with default file type and/or folder rules for determining which files to continuously back up on the hazard protected backup server 50. For example, the backup client software 60 may by default designate for continuous back up all known file extensions for word processing documents, spreadsheet documents, database files, financial record files, etc. The backup client software 60 may also designate folders, such as “My Documents” or “Desktop” for backup such that all files and/or subfolders in the designated folder are backed up regardless of extension. By default, the backup client software 60 is configured to store the most recent version of a designated file on the hazard protected backup server 50, but the backup client software 60 may be configured to store multiple versions of a file on the hazard protected backup server 50. As the number of versions increases, the net capacity of the storage unit 80 decreases.

During the initial configuration or at a later time, the user may designate other files, extensions, or folders for continuous backup, but such customization is not necessary to establish the functionality of the hazard protected backup server 50.

The backup client software 60 does not wait to perform periodic backups at predetermined time intervals, but rather, the backup client software 60 continuously monitors the workstation 20 or notebook 30 and the designated files are transferred by the backup client software 60 to the hazard protected backup server 50 in real time, as they are created and modified. This immediacy aspect of the backup protection provides a high level of protection and efficiency.

In accordance with the default configuration rules, the backup client software 60 cooperates with the hazard protected backup server 50 to establish the backup functionality with virtually no technical expectations for the user. The default rules cover the vast majority of important files that are created by the user. The breadth and simplicity obviates the need for internal IT expertise or the use of outside consultant expertise to configure the backup functionality.

In some instances, the connection between the workstation 20 or notebook 30 and the network 40 may be lost. For example, a notebook 30 may be taken outside the office environment by a mobile user. In other instances, planned or unplanned maintenance may require the network 40 to be shut down. In these instances, the backup client software 60 continues to monitor and identify files designated for backup, but cannot detect the presence of the hazard protected backup server 50. The backup client software 60 stores the designated files in a backup queue 140. Although a backup queue 140 may be employed with any device on the network 40, it is most likely to be used in conjunction with one of the notebook computers 30, and is illustrated as such in FIG. 1. The backup client software 60 polls the network 40 to establish or maintain a connection to the hazard protected backup server 50. When the presence of the hazard protected backup server 50 is detected at some later time, the backup client software 60 transfers files stored in the backup queue 140 to the hazard protected backup server 50. The backup client software 60 may be equipped with a status monitoring functionality that indicates to the user that the hazard protected backup server 50 is not currently available. This indication informs the user that files are not being continuously backed up, but rather they are being stored in the backup queue 140.

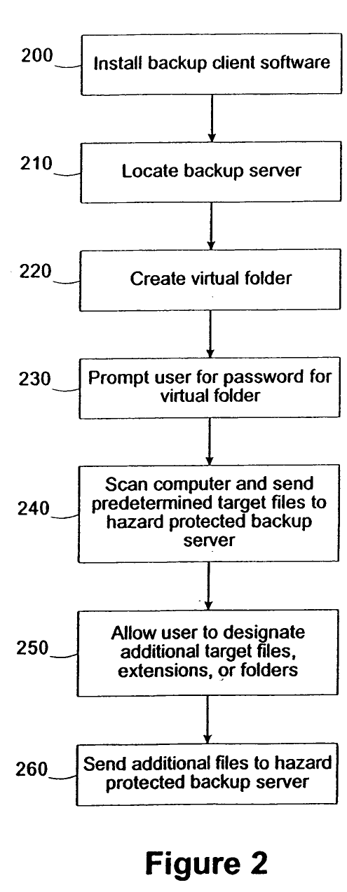

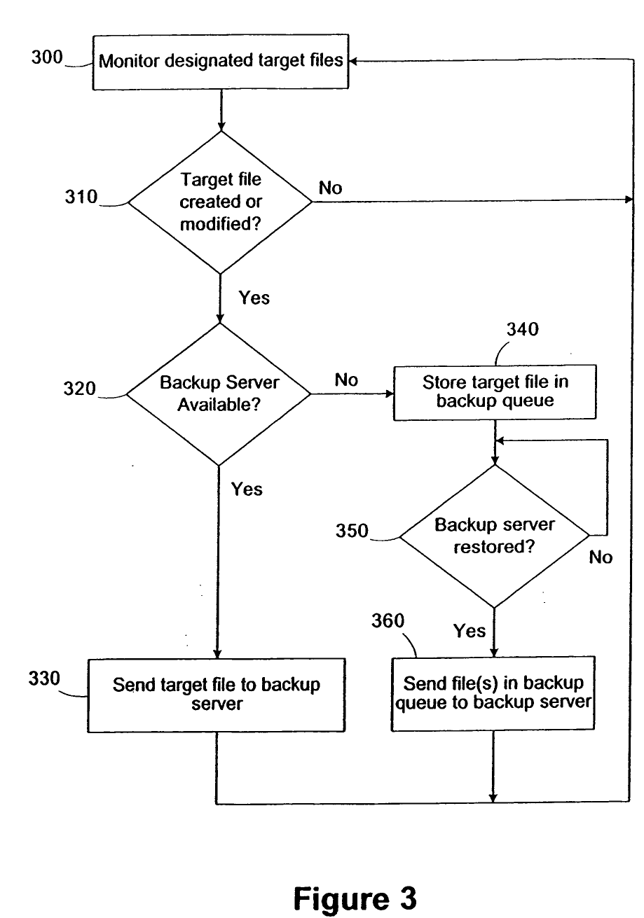

Turning now to FIGS. 2 and 3, simplified flow diagrams of methods implemented by the backup client software 60 for backing up designated target files are provided. FIG. 2 illustrates a configuration phase implemented by the backup client software 60, and FIG. 3 illustrates a monitoring phase implemented by the backup client software 60. Although the method steps are illustrated and discussed in a certain order, the application of the present invention is not limited to any particular order of steps. The order may be changed or various tasks may be combined or performed in parallel.

Referring first to FIG. 2, in block 200, the user installs the backup client software 60 on the associated computer 20, 30. The user implements a one-click installation, and the backup client software 60 performs the majority of the backup configuration without requiring user expertise or involvement with the default profile. In block 210, the backup client software 60 locates the hazard protected backup server 50 on the network, and in block 220, the backup client software 60 directs the hazard protected backup server 50 to create a virtual folder 110 for the associated computer 20, 30.

In block 230, the backup client software 60 prompts the user for a password to protect the virtual folder 110. The hazard protected backup server 50 maintains the password. When the user subsequently accesses the virtual folder 110, the backup client software 60 prompts the user again for the password and forwards the password to the hazard protected backup server 50 for verification.

In accordance with its default configuration rules, the backup client software 60 scans the computer for predetermined target files and transfers the identified files to the hazard protected backup server 50 for backup within the virtual folder 110. This action establishes the backup functionality of the hazard protected backup server 50 and if no further action is taken by the user, the vast majority of important files would have been continuously backed up on the hazard protected backup server 50.

In block 250, the backup client software 60 allows the user to optionally specify additional target files, extensions, or folders for continuous backup, and the additional target files are transferred to the hazard protected backup server 50 in block 260.

Referring now to FIG. 3, the monitoring functions performed by the backup client software 60 are now illustrated. In block 300, the backup client software 60 monitors the computer to identify designated target files (i.e., having been designated by name, extension, or folder). In block 310, if one of the designated target files is created or modified, the backup client software 60 determines if the hazard protected backup server 50 is available in block 320. If the hazard protected backup server 50 is available, the backup client software 60 transfers the target file in block 330 for storage in the virtual folder 110 for the computer 20, 30 on the storage unit 80, and returns to monitoring the designated target files in block 300.

If the hazard protected backup server 50 is not available in block 320, the backup client software 60 stores the target file in the backup queue 140. If the hazard protected backup server 50 is restored in block 350, the backup client software 60 transfers the file(s) stored in the backup queue 140 to the hazard protected backup server 50 in block 360, and returns to monitoring the designated target files in block 300.

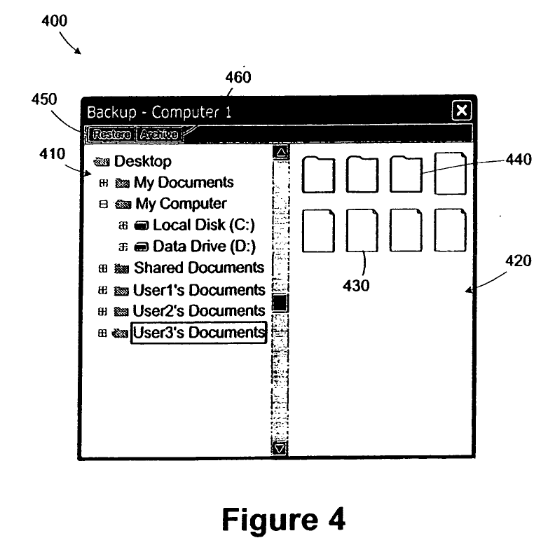

Turning now to FIG. 4, an exemplary user display 400 provided by the backup client software 60 to illustrate the virtual folder 110 is provided. The user display 400 is provided for illustrative purposes and is not intended to be limiting. The user display 400 displays the contents of the backup folder 120 using a directory tree 410 and contents frame 420 matching the directory tree of the associated computer 20, 30. Hence to locate a backup file, the user simply selects the folder in the directory tree 410 corresponding to the storage location on the computer 20, 30. The contents of the selected folder, such as documents 430 or other folders 440, are displayed in the contents frame 420.

If the user desires to perform a restore operation, the appropriate file or folder may be selected, and the user may activate a restore control button 450. Subsequently, the backup client software 60 copies the file to its original location. Alternatively, the user may designate a different location for the restored file.

If the user wants to permanently archive a selected file or folder, they may click on an archive control button 460, responsive to which, the backup client software 60 will copy the selected file to the archive folder 130.

Of course other interfaces may be provided for exploring the contents of the virtual folder 110 or designating files for archiving. For example, an icon representing the archive folder 130 may be displayed, and the user may drag selected files or folders (e.g., from their computer 20, 30 or from the backup folder 120) over the icon to cause them to be copied to the archive folder 130. Again, the user would be prompted to enter a password to store files in the archive folder 130.

In order to achieve an enterprise-class disaster-resistant automated backup appliance, many solutions may be devised within the spirit and scope of the present invention. The embodiment of the present invention described above can include a RAID 5 hard drive array enclosed in a water-resistant, UL150 fire-resistant casing, for example. While this allows users a robust platform, the cost of the casing can be significantly high, deterring potential users from purchasing such a system. In order to reach a larger market, the present invention can include a hybrid approach which cut costs while still achieving a high level of performance, redundancy, and disaster-resistance.

In such an alternative embodiment, the present invention can include this hybrid approach which has a “BASE” model initially, which is upgradable to the full “disaster-resistant” functionality when a user is ready: both as compliance changes, and as additional finances become available.

For example, a BASE model automated backup appliance can provide the user with a fast, hardware redundant, enterprise class continuous data backup Network Attached Storage (NAS) device. This appliance protects against hard-drive failure, accidental user deletion, as well mitigating any risk with forgotten backups or poorly configured backup scheduling. While this suffices for many users, it will not meet the criteria of those who prefer (or require) an off-site data backup to protect against disasters (either mad-made or natural). In order to meet the demand of these select users, the present invention provides an expansion “disaster-pack” either as a later upgrade, or in conjunction with the BASE model.

The BASE model can include a NAS device, but in conjunction with its embedded operating system (OS) and client software, it functions as an Automated Backup Appliance. Due to the required hardware redundancy, quick speed and extensive storage needed for such a device to properly function in a multi-user environment (up to 100 users), this device is provided in a “soft casing” (not disaster-resistant). This BASE model suffices for the real-time tasks it is created for (continuous real-time data backup and retrieval), and due to its extensive storage allow multiple versions of each file (currently defaults to eight, although configurable by the user). In order to cost-effectively provide disaster-resistance to the BASE model, the present invention can include an expansion pack (“disaster-pack”) which may be added as a later upgrade, or in conjunction with the BASE model. The disaster-pack can include a single hard-disk encased in a water, fire and impact resistant enclosure (which meets at least UL150 water-resistant media safe criteria, for example). This hard drive can be passively cooled by transferring heat from the hard drive via a heat pipe to an exterior radiator. The heat-pipe quickly disconnects in event of a fire, triggering a protective material to cover the exposed heat-pipe quick disconnect fitting, ensuring heat from the fire does not transfer to the internal hard drive.

The disaster-pack model can interface with the BASE model via a USB 2.0 cable, for example. As files continuously backup to the BASE model, select versions of the files (currently two versions for each file, but can be configured by the user to include more or less versions for each file) are archived to the disaster-pack expansion module for disaster-resistant storage. While two versions of a file may not meet the criteria of the feature-rich functionality of the BASE model, it suffices in the event of disaster (as current compliance plans may only require a single copy to be archived off-site for disaster protection).

Since only a single hard-drive is included in a disaster-pack expansion module, the manufacturing costs are significantly lower than enclosing an entire NAS in a similar case. A single hard-drive may not achieve the hardware redundancy, speed and features needed for an automated backup appliance for a multi-user environment. Likewise a enterprise-class, hardware-redundant NAS may be cost prohibitive when encased in a disaster-resistant enclosure, as compared with encasing a single-drive in a disaster-resistant enclosure. Therefore, with a hybrid approach according to the present invention, both criteria (enterprise-class NAS and disaster-resistance) can be relatively easily and affordably achieved.

The BASE model can include four hard-drives for example, and a corresponding to a single drive in the disaster-pack module. The BASE model can expand to eight hard-drives if needed, or another number, and then a hybrid approach according to the present invention may be achieved by affixing two single-drive disaster-pack modules to the BASE model, or by encasing two drives in a single disaster-pack. Another criteria for configuration of the disaster-pack (besides the UL150 criteria) is that it has at least a predetermined percentage, say 25%, of the capacity of its corresponding BASE model (in order to properly archive a critical number of file versions). This percentage can vary based on the particular application/installation to be between 10% and 90%. In order to scale with a growing user installation which may have install multiple BASE models in a single site, the disaster-pack module may grow in size containing dozens of internal hard-drives in a single enclosure. While the cooling method for such a enclosure may deviate from a heat pipe configuration, the presently inventive concept to properly cool and protect against a fire is maintained. The disaster-pack automatically archives select file versions of all files on the BASE model backup device(s) (which may require at least 25% of the BASE models storage capacity, for example). This hybrid approach can continue to scale with growing installations, allowing the feature-rich, enterprise-class BASE model to perform their daily tasks, and the disaster-pack to act as an emergency archive in event of a disaster. This results in a significant cost reduction in comparison to encasing every BASE model in a disaster-resistant case.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### REFERENCE NUMERALS

10 computer system
20 workstation
30 notebook
40 network
50 hazard protected backup server
60 backup client software
70 backup server
80 storage unit
90 first enclosure
100 second enclosure
110 virtual folder
120 backup folder
130 archive folder
140 backup queue
200-360 method blocks
400 user display
410 directory tree
420 contents frame
430 documents
440 folders
450 restore control button
460 archive control button

We claim:

1. A hazard protected file backup system, comprising:
a first storage unit operable to receive and store digital data;
a hazard resistant enclosure surrounding the storage unit; and
a backup server operable to receive designated backup files and store at least some of the designated backup files on the first storage unit.

2. The hazard protected file backup system of claim 1, further including a second storage unit operable to receive and store digital data, the backup server operable to store the designated backup files on the second storage unit, wherein the first storage unit stores a subset of the designated backup files.

3. The hazard protected file backup system of claim 2, wherein at least one of the first storage unit and the second storage unit are expandable to include additional storage capacity.

4. The hazard protected file backup system of claim 2, wherein at least one of the first storage unit and the second storage unit are a redundant array of hard disk drives.

5. The hazard protected file backup system of claim 4, wherein the redundant array of hard disk drives allows, in an event of a failed member disk drive, restoration of the failed member data on a remaining disk drive.

6. The hazard protected file backup system of claim 1, further including an access-controlled enclosure surrounding the hazard resistant enclosure and the backup server.

7. The hazard protected file backup system of claim 1, further including a computer connected to the backup server, the computer operable to execute backup client software to continuously monitor the computer to identify at least some of the designated backup files for continuous backup.

8. The hazard protected file backup system of claim 7, wherein the backup client software includes a status monitoring functionality that indicates the status of the backup server, the status monitoring functionality has at least a current availability of the backup server.

9. The hazard protected file backup system of claim 7, wherein the storage unit is operable to store a virtual folder for the computer, the virtual folder including a backup folder for continuous backup and an archive folder for permanent backup, the backup client software is further operable to transfer the designated target files to the backup server for storage in the backup folder.

10. The hazard protected file backup system of claim 7, wherein the storage unit is operable to store a backup folder for the computer, the backup client software is further operable to transfer the designated target files to the backup server for storage in the backup folder responsive to the backup server being available and to store the designated target files in a backup queue responsive to the backup server being unavailable.

11. The hazard protected file backup system of claim 1, further including a heat transfer device connected to the hazard resistant enclosure for transferring heat from the storage unit to an outside of the hazard resistant enclosure, wherein the heat transfer device automatically disconnects from the outside in an event of a fire.

12. The hazard protected file backup system of claim 11, wherein said heat transfer device is a heat pipe.

13. A computer system, comprising:
a computer operable to execute backup client software to continuously monitor the computer to identify designated target files for continuous backup; and
a backup server including a storage unit operable to store a virtual folder for the computer, the virtual folder including a backup folder for continuous backup and an archive folder for permanent backup, wherein the backup client software is further operable to transfer the designated target files to the backup server for storage in the backup folder.

14. The computer system of claim 13, further including a hazard resistant enclosure surrounding the storage unit.

15. The computer system of claim 13, wherein the storage unit includes a first storage unit, a second storage unit, and a hazard resistant enclosure surrounding the first storage unit.

16. The computer system of claim 15, wherein the archive folder includes a hazard protected folder which is a subset of the backup folder, the first storage unit storing the hazard protected folder.

17. A computer system, comprising:
a computer operable to execute backup client software to continuously monitor the computer to identify designated target files for continuous backup; and
a backup server including a storage unit operable to store a backup folder for the computer, wherein the backup client software is further operable to transfer the designated target files to the backup server for storage in the backup folder responsive to the backup server being available and to store the designated target files in a backup queue responsive to the backup server being unavailable.

18. The computer system of claim 17, further including a hazard resistant enclosure surrounding the storage unit.

19. The computer system of claim 17, wherein the storage unit includes a first storage unit, a second storage unit, and a hazard resistant enclosure surrounding the first storage unit.

20. The computer system of claim 19, wherein the backup folder includes a hazard protected folder which is a subset of the backup folder, the first storage unit storing the hazard protected folder.
